(19) United States
(12) Patent Application Publication
(10) Pub. No.: US 2002/0121858 A1
(43) Pub. Date: Sep. 5, 2002

(54) Short wavelength ZnO light emitting device and the manufacturing method thereof

(76) Inventors: Young-Chang Kim, Seoul (KR); Sang-Yeol Lee, Seoul (KR)

Correspondence Address: Jonanthan Y. Kang, Lee & Hong, 11th Floor, 221 N. Figueroa Street, Los Angeles, CA, 90012, US

(21) Appl. No.: 09/995,448

(22) Filed: Nov. 27, 2001

(30) Foreign Application Priority Data
Mar. 5, 2001 (KR) 2001-11176
May 30, 2001 (KR) 2001-30051

(51) Int. Cl. H05B 33/14

(52) U.S. Cl. 313/499

(57) ABSTRACT

The present invention relates to a short wavelength ZnO light emitting device and the manufacturing method thereof, which forms materials of p-type by doping Zn on InP, deposits a thin layer of ZnO on an upper surface of the doped layer and forms a p-n junction, thereby obtaining a stable crystal structure and enhances the effectiveness. The short wavelength ZnO light emitting device comprises a Zn doped InP layer of p-type formed by doping Zn on a substrate of InP and then replacing In with Zn; and a ZnO layer deposited on the Zn doped InP substrate whereby a forward bias voltage is applied to the doped InP and the ZnO layers, which are doped Zn, thereby obtaining a light emitting characteristic of short wavelength. A ZnO-based semiconductor light emitting device can be used as a blue and purple light source, and is expected to have more excellent characteristics in displays.

### BACKGROUND OF THE INVENTION

1. Field of the Invention

The present invention relates to a short wavelength ZnO light emitting device and the manufacturing method thereof, and more particularly, to a short wavelength ZnO light emitting device which forms a p-n junction by forming p-type material forming a junction with ZnO so that ZnO is applied as a stable n-type for generating a short wavelength and the manufacturing method thereof.

2. Description of the Related Art

In our technical world, displays have an important function as human interfaces for making abstract information available through visualization. In the past, many applications for displays were identified and realized, each with its own specific requirements. Therefore, different display technologies have been developed, each having their own strengths and weaknesses with respect to the requirements of particular display applications, thus making a particular display technology best suited for a particular class of applications.

Light emitting diodes (LED) which emit light spontaneously under forward bias conditions have various fields of application such as indicator lamps, devices of visual displays, light sources for an optical data link, optical fiber communication, etc.

In the majority of applications, either direct electronic band-to-band transitions or impurity-induced indirect band-to-band transitions in the material forming the active region of the LED are used for light generation. In these cases, the energy gap of the material chosen for the active region of the LED, i.e. the zone where the electronic transitions responsible for the generation of light within the LED take place, determines the color of a particular LED.

A further known concept for tailoring the energy of the dominant optical transition of a particular material and thus the wavelength of the generated light is the incorporation of impurities leading to the introduction of deep traps within the energy gap. In this case, the dominant optical transition may take place between a band-state of the host material and the energy level of the deep trap. Therefore, the proper choice of an impurity may lead to optical radiation with photon energies below the energy gap of the host semiconductor.

Today, exploiting these two concepts for tailoring the emission wavelength of an LED and using III-V or II-VI compound semiconductors or their alloys for the active region of the LED, it is possible to cover the optical spectrum between near infrared and blue with discrete emission lines.

Blue light emitting MIS diodes have been realized in the GaN system. Examples of these have been published in:

“Violet luminescence of Mg-doped GaN” by H. P. Maruska et al., Applied Physics Letters, Vol. 22, No. 6, pp. 303-305, 1973,

“Blue-Green Numeric Display Using Electroluminescent GaN” by J. I. Pankove, RCA Review, Vol. 34, pp. 336-343, 1973,

“Electric characteristics of GaN: Zn MIS-type light emitting diode” by M. R. H. Khan et al., Physica B 185, pp. 480-484, 1993,

“GaN electroluminescent devices: preparation and studies” by G. Jacob et al., Journal of Luminescence, Vol. 17, pp. 263-282, 1978,

EP-0-579 897 A1: “Light-emitting device of gallium nitride compound semiconductor” .

Unfortunately, the present-day LEDs suffer from numerous deficiencies. Light emission in the LED is spontaneous, and, thus, is limited in time on the order of 1 to 10 nanoseconds. Therefore, the modulation speed of the LED is also limited by the spontaneous lifetime of the LED.

Attempts were made to improve the performance of the LEDs. For example, a short wavelength blue semiconductor light emitting device has been developed. The compound semiconductor device of gallium nitrite series such as GaN, InGaN, GaAlN, InGaAlN has been recently considered as a material of the short wavelength semiconductor light emitting device.

For example, in the semiconductor light emitting device using GaN series material, a room temperature pulse oscillation having wavelength of 380 to 417 nm is confirmed.

However, in the semiconductor laser using GaN series material, a satisfying characteristic cannot be obtained, a threshold voltage for a room temperature pulse oscillation ranges from 10 to 40 V, and the variation of the value is large.

This variation is caused by difficulty in a crystal growth of the compound semiconductor layer of gallium nitride series, and large device resistance. More specifically, there cannot be formed the compound semiconductor layer of p-type gallium nitride series having a smooth surface and high carrier concentration. Moreover, since contact resistance of a p-side electrode is high, a large voltage drop is generated, so that the semiconductor layer is deteriorated by a heat generation and a metal reaction even when the pulse oscillation is operated. In consideration of a cheating value, the room temperature continuous oscillation cannot be achieved unless the threshold voltage is reduced to less than 10 V.

Moreover, when a current necessary to the laser generation is implanted, the high current flows locally and a carrier cannot be uniformly implanted to an active layer, and an instantaneous breakage of the device occurs. As a result, the continuous generation of the laser cannot be achieved.

In the light-emitting device of GaN series, since the p-side electrode contract resistance was high, the operating voltage was increased. Moreover, nickel, serving as a p-side electrode metal, and gallium forming the p-type semiconductor layer, were reacted with each other, melted, and deteriorated at an electrical conduction. As a result, it was difficult to continuously generate the laser.

Besides, SiC and ZnO are known as short wavelength light emitting materials.

However, SiC and ZnO are disadvantageous in that the chemical crystalline thereof is very unstable or a crystal growth itself is difficult for SiC and ZnO to be used as compounds semiconductors required for blue light emission. In case of SiC, it is chemically stable, but the lifetime and brightness thereof are low for SiC to be put into practical use.

Meanwhile, in case of ZnO, it is proper material for blue light emission and shorter wavelength light emission since it has a characteristic similar to GaN. Moreover, ZnO has an exciton binding energy (e.g., 60 meV) about three times larger than that of GaN, it is judged to be a very proper material for short wavelength light element of the next generation.

Nevertheless, even though there was a case where ZnO was manufactured as a p-n junction, the light emission efficiency thereof was very low and thus the availability thereof as an actual device is very low, and it is difficult for ZnO to form a p-type material.

### SUMMARY OF THE INVENTION

It is, therefore, an object of the present invention to provide a short wavelength ZnO light emitting device and the manufacturing method thereof, which forms materials of p-type by doping Zn on InP, deposits a thin layer of ZnO on an upper surface of the doped layer and forms a p-n junction, thereby obtaining a stable crystal structure and enhance the effectiveness.

In order to achieve the above-described objects of the present invention, there is provided a short wavelength ZnO light emitting device including: a Zn doped InP layer of p-type formed by doping Zn on a substrate of InP; and a ZnO layer deposited on the Zn doped InP substrate whereby a forward bias voltage is applied to the Zn doped InP and the ZnO layers, thereby obtaining a light emitting characteristic of short wavelength.

Preferably, a thickness of the Zn doped InP layer of a p-type is 1˜3 μm.

Preferably, the Zn formed on the substrate of InP is doped at the temperature of 400 to 600 ° C. in a vacuum ample of 10⁻⁶ Torr.

In an another aspect, there is provided a method for manufacturing a short wavelength ZnO light emitting device, comprising the steps of: forming a Zn doped InP layer by doping Zn on a substrate of InP in order to form a p-type material; depositing a ZnO layer on the Zn doped InP substrate as an n-type material in order to form a p-n junction; and forming lower and upper electrodes on the InP and the ZnO layers, which are doped Zn, respectively.

Preferably, in the step for doping Zn on the substrate of InP, the Zn doping is performed at the temperature of 400 to 600 ° C. in a vacuum ample of 10⁻⁶ Torr.

### BRIEF DESCRIPTION OF THE DRAWINGS

The above objects, features and advantages of the present invention will become more apparent from the following detailed description when taken in conjunction with the accompanying drawings, in which:

FIG. 1 is a view illustrating a general InP substrate;

FIG. 2 is a view illustrating the doping step for forming materials of p-type in the manufacturing method of a short wavelength ZnO light emitting device in accordance with a first embodiment of the present invention;

FIG. 3 is a view illustrating the step of depositing a n-type thin film on a p-type substrate in the manufacturing method of a short wavelength ZnO light emitting device in accordance with the first embodiment of the present invention;

FIG. 4 is a view illustrating the formation of electrodes at a p-n junction in the manufacturing method of a short wavelength ZnO light emitting device in accordance with the first embodiment of the present invention;

FIG. 5 is a view illustrating a forward bias voltage applied to the short wavelength ZnO light emitting device in accordance with the first embodiment of the present invention;

FIG. 6 is a view illustrating defect levels in the dominant electronic transition of the short wavelength ZnO light emitting device in accordance with the first embodiment of the present invention; and

FIG. 7 is a graph illustrating a PL characteristic according to the thickness of a ZnO thin film in the short wavelength ZnO light emitting device in accordance with the first embodiment of the present invention.

### DETAILED DESCRIPTION OF THE PREFERRED EMBODIMENT

A preferred embodiment of the present invention will now be described with reference to the accompanying drawings.

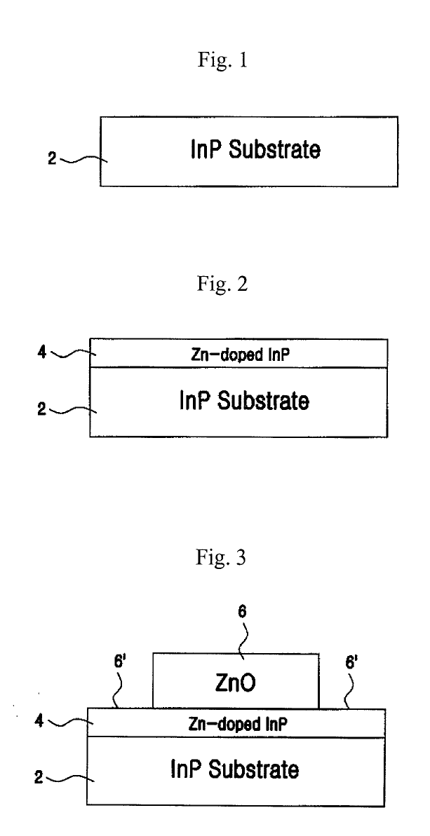

FIG. 1 is a view illustrating a general InP substrate.

Referring to this, an InP substrate 2 adapted for use as a lower substrate of the present invention is not doped and does not contain impurity, and thus p-type or n-type materials weak enough to be ignored may be formed on the upper surface thereof due to unbalanced elements. However, this phenomenon may be ignored by the process of doping Zn at a much higher concentration FIG. 2 is a view illustrating the doping step for forming materials of p-type in the manufacturing method of a short wavelength ZnO light emitting device in accordance with a first embodiment of the present invention.

Referring to this, in the present invention, a Zn doped InP layer of p-type is formed by doping Zn on the InP substrate 2 with Zn.

Preferably, on the upper surface of the Zn doped InP 4, n-type material are easily deposited by doping Zn on InP and then forming InP as p-type.

At this time, the Zn formed on the substrate 2 of InP is diffusion-doped for about 40 minutes at the temperature of 400 to 600 ° C. in a vacuum ample of 10⁻⁶ Torr. After the diffusion, a thickness of the thin film is 1˜3 μm.

With respect to the doping, a p-type substrate is formed by doping Zn material for a predetermined time in order to form the p-type InP substrate 2.

Therefore, the thickness of the Zn doped InP layer 4, a formed p-type material, is 1˜3 μm, and the Zn doped InP layer 4 acts as a base substrate in depositing an n-type layer on the upper surface thereof.

FIG. 3 is a view illustrating the step of depositing an n-type thin film on a p-type substrate in the manufacturing method of a short wavelength ZnO light emitting device in accordance with the first embodiment of the present invention.

Referring to this, in FIG. 3, a ZnO layer 6 of n-type is applied and thus is deposited as a mesa structure on the upper surface of a p-type substrate (for example, the Zn doped InP layer 4) formed by the step of FIG. 2. At this time, the mesa structure is a structure for increasing the efficiency of light emission, in which the light emission characteristic is improved by exposing an interface 6′ which is a main factor of light emission, and also in which electrodes may be deposited on the upper surface of the Zn doped InP layer 4 of p-type material by exposing the interface 6′.

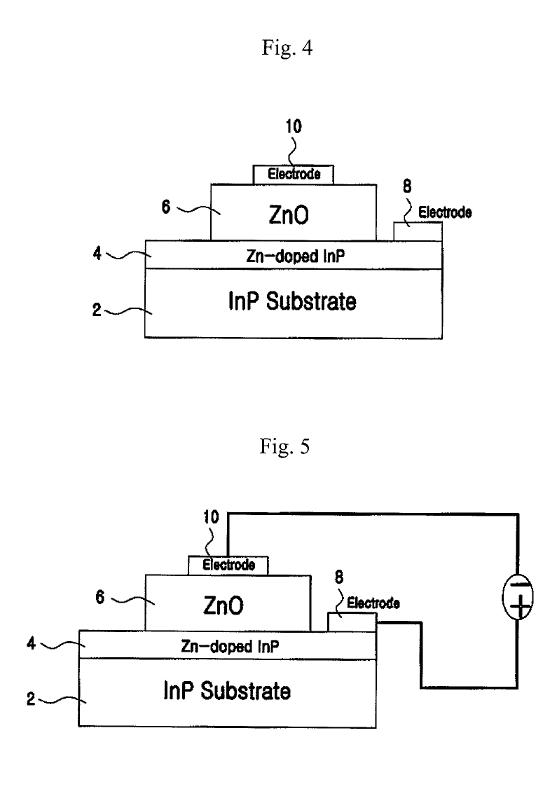

FIG. 4 is a view illustrating the formation of electrodes at a p-n junction in the manufacturing method of a short wavelength ZnO light emitting device in accordance with the first embodiment of the present invention.

Referring to this, a lower electrode 8 and an upper electrode 10 are formed respectively on p-n junction layers formed in FIG. 3, for example, on the Zn doped InP layer 4 and the ZnO layer 6.

FIG. 5 is a view illustrating a forward bias voltage applied to the short wavelength ZnO light emitting device in accordance with the first embodiment of the present invention.

Referring to this, in FIG. 4, a forward voltage are applied on the lower electrode 8 and the upper electrode 10 each formed on the Zn doped InP layer 4 and the ZnO layer 6, for example, a + voltage and a − voltage are applied respectively on the lower electrode 8 and the upper electrode 10. Then, electroluminescence takes place on the short wavelength semiconductor light emitting device according to the present invention.

The short wavelength ZnO light emitting device manufactured by the above method has a wurtzite structure of a hexagonal system, and is a p-n junction short wavelength light emitting device employing ZnO which is a II-VI group semiconductor having a large band gap of 3.37 eV and having a direct transition characteristic.

The short wavelength ZnO light emitting device is a p-n junction LED manufactured by forming a p-type material (for example, Zn doped InP) effectively forming a junction with ZnO which becomes n-type material directly after growth, depositing a n-type ZnO thin film on the p-type material and confirming the EL characteristic.

For this purpose, the present invention introduces a material referred to as InP in forming a p-type material. In case of doping Zn on the InP as a direct-type semiconductor, the Zn acts as a substitute for the InP region, for thereby forming a p-type material.

Therefore, the ZnO thin film layer 6 is deposited as a mesa structure on the upper surface of the Zn doped InP layer 4 which has formed the p-type material by doping Zn on InP, for thereby forming a p-n junction. In this structure, the LED is manufactured by confirming the EL (Electro-luminescence) characteristic.

In other words, when a forward bias voltage is applied on the Zn doped InP layer 4 and the ZnO layer 6, electrons and holes are moved respectively in a positive electrode direction and in a negative electrode direction by the effect of electric fields. This leads to the overabundance of electrons within the p-type material (Zn doped InP layer: 4) and the overabundance of holes within the n-type material (ZnO layer: 6), for thereby resulting in the existence of an excessive dose of electrons and holes in the same region.

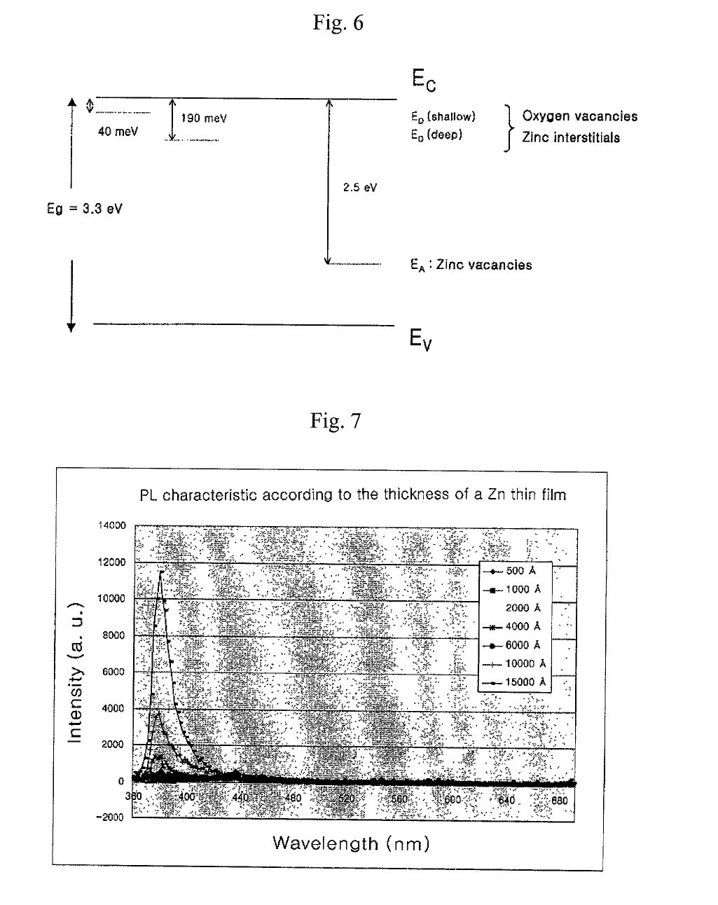

FIG. 6 is a view illustrating an impurity state in the main electronic transition of the short wavelength ZnO light emitting device in accordance with the first embodiment of the present invention.

Referring to this, ZnO is oxygen deficient type oxide of ZnₓOₓ₋₁ thought it is known as an n-type semiconductor. In order that ZnO becomes oxygen depletion type oxide of n-type, it is necessary that either oxygen vacancies or Zn interstitial exist, or both oxygen vacancies and Zn interstitial exist.

In addition, since the crystalline of ZnO is oxygen deficient type oxide, the following binding reactions are made.

Firstly, oxygen atoms form oxygen vacancies while they are moved from their normal lattice positions onto external gases. At this time, the oxygen vacancies are ionized for thereby emitting electrons and acting as donors.

Secondly, Zn in normal lattice positions become Zn interstitial, the Zn interstitial being easily ionized. In this case, also, they act as donors like oxygen vacancies do, provide electrons and represent n-type semiconductor characteristics. Like oxygen vacancies, the Zn have a donor level very similar to a conduction band edge and thus are easily ionized at a room temperature.

In case of Zn interstitial, a second ionizing process is performed thereon. In this process, also, electrons are provided. That is, in order that the short wavelength ZnO light emitting device according to the present invention have emission characteristics, it is necessary to perform at least one of the above ionizing processes.

The functions and operations of the short wavelength ZnO light emitting device in accordance with the first embodiment of the present invention will now be described in detail with reference to the accompanying drawings.

The short wavelength light emitting device according to the present invention employs direct electronic band-to-band transitions caused by a p-n junction between the Zn doped InP layer 4 and the ZnO layer 6 which form an active region of the LED for light generation.

More specifically, with respect to the active region of the LED according to the present invention, the ZnO layer 6 has a large band gap of 3.37 eV and forms a very stable thin film, thus making it easy to implement blue light emission or a color of a shorter wavelength.

Furthermore, the short wavelength ZnO light emitting device according to the present invention can bring about optical radiation with a photon energy below the energy gap of InP and ZnO by a p-n junction between the Zn doped InP layer 4 and the ZnO layer 6.

FIG. 7 is a graph illustrating a PL characteristic according to the thickness of a Zn thin film in the short wavelength ZnO light emitting device in accordance with the first embodiment of the present invention.

Referring to this, the overall thickness of the short wavelength ZnO light emitting device is differentiated according to the thickness of Zn doped on the InP substrate 2. Therefore, the peak and peak wavelength of an emission spectrum are affected by the thickness of the short wavelength ZnO light emitting device.

As shown in FIG. 7, this drawing is a linear graph according to the thickness of the short wavelength ZnO light emitting device (when Ar ion laser of 315 nm is irradiated.).

While the invention has been shown and described with reference to certain preferred embodiments thereof, it will be understood by those skilled in the art that various changes in form and details may be made therein without departing from the spirit and scope of the invention as defined by the appended claims.

As seen from above, in the short wavelength ZnO light emitting device and the manufacturing method thereof according to the present invention, a LED based on ZnO which has similar characteristics to GaN, which is a proper material for blue light emission and light emission of a shorter wavelength, which has a very large excitation binding energy of about 60 meV that is three times as large as GaN, and thus which is judged to be a very proper material for the next short wavelength light element. A ZnObased semiconductor light emitting device can be used as a blue and purple light source which is the core technology of the next generation DVD, and is expected to have more excellent characteristics in displays than the exiting blue light emitting device. In addition, the structure of the present invention can be substantially adapted to a LD based on ZnO.

What is claimed is:

1. A short wavelength ZnO light emitting device comprising:
a Zn doped InP layer of p-type formed by doping Zn on a substrate of InP and then replacing In with Zn; and
a ZnO layer deposited on the Zn doped InP substrate whereby a forward bias voltage is applied to the Zn doped InP and the ZnO layers, thereby obtaining a light emitting characteristic of short wavelength.

2. The device according to claim 1, wherein a thickness of the Zn doped InP layer of a p-type is 1˜3 μm.

3. The device according to claim 1, wherein the Zn formed on the substrate of InP is doped at the temperature of 400 to 600 ° C. in a vacuum ample of 10⁻⁶ Torr.

4. A method for manufacturing a short wavelength ZnO light emitting device, comprising the steps of:
forming a Zn doped InP layer by doping Zn on a substrate of InP in order to form a p-type material;
depositing a ZnO layer on the Zn doped InP substrate as an n-type material in order to form a p-n junction; and
forming lower and upper electrodes on the InP and the ZnO layers, which are doped Zn, respectively.

5. The method according to claim 4, wherein in the step for doping Zn on the substrate of InP, the Zn doping is performed at the temperature of 400 to 600 ° C. in a vacuum ample of 10⁻⁶ Torr.
